(19) United States
(12) Patent Application Publication
(10) Pub. No.: US 2003/0100320 A1
(43) Pub. Date: May 29, 2003

(54) Efficient hyperlinks for transmitted hyperlinked information

(76) Inventor: Peeyush Ranjan, Sammamish, WA (US)

Correspondence Address: Robert W. Bergstrom, SUMMIT LAW GROUP, PLLC, Suite 300, 1505 Westlake Ave., Seattle, WA, 98109, US

(21) Appl. No.: 10/001,081

(22) Filed: Oct. 31, 2001

(51) Int. Cl. H04J 3/24; H04Q 7/20

(52) U.S. Cl. 455/466; 370/349

(57) ABSTRACT

A method and system for efficiently transmitting embedded links within formatted text documents that describe web pages to a remote electronic device that displays information extracted from web pages. A server computer transcribes information contained in web pages into packets of textual information that can be transmitted to, and displayed on, the remote electronic device. In transcribing information contained in web pages, the server computer replaces embedded links with short link tokens and stores associations between embedded links and link tokens in order to later resolve link tokens into embedded links.

### TECHNICAL FIELD

The present invention relates to the transmission of hyperlinked information by a server computer for display on a remote electronic device and, in particular, to a method and system for efficiently transmitting and displaying hyperlinks embedded within the hyperlinked information.

### BACKGROUND OF THE INVENTION

Although the Internet has been widely used for exchange of information for o, exploitation of the Internet as a mass-media broadcast medium and a commercial and information exchange medium developed during the past ten years as a result of the development of the hypertext markup language (“HTML”), the development of web browsers for displaying web pages described in HTML documents, and the increasing performance of, and decreasing price of, personal computers. Wide acceptance of the Internet has motivated significant research, development, and commercial activity directed to transmitting and displaying web pages from server computers to portable, hand-held electronic devices, such as cellular telephones, to allow mobile access to the Internet and access to the Internet through electronic devices less expensive and more conveniently used than personal computers.

FIG. 1 shows an example of a simple web page displayed on an electronic display device. The web page 100 graphically displays information encoded in an HTML document. Information displayed on the web page may include textual information, such as the name 102 and address 104 of a commercial entity, graphical information, such as a photograph or animation 106, and hyperlinks 108-109, also known simply as “links.” A link in a web page is commonly displayed as a word or phrase, highlighted by underlining, contrasting color or font, and the like, that represents a web page that can be displayed to a user as the result of the user inputting a mouse click or other input indication to a position on the display device overlying the displayed link. For example, a user viewing the web page 100 in FIG. 1 on a personal computer may manipulate a mouse to place a graphically displayed mouse cursor over the link “Customer Testimonials” 109 and input a mouse click to the mouse in order to direct a software browser running on the personal computer to fetch a web page described by the link “Customer Testimonials” 109 from a remote server and display the web page to the user. Hyperlinks allow a user to conveniently navigate through web pages linked together via the hyperlinks. In many cases, hyperlinked information is hierarchically linked and organized, but in many other cases, hyperlinked information may be topologically linked and organized as a more general, mesh-like mathematical structure referred to as a “graph.”

An HTML document describing a web page is a text document formatted according to the HTML specification. The details of representing web pages in HTML documents are well known to ordinarily skilled Internet application developers and software engineers. In particular, specification of a link within an HTML document is accomplished using an href tag. For example, an href tag that might represent link 108 in FIG. 12 is shown below:

<a href = “http://www.heath.foodscience.universityofplainsville.edu
/news/chocolatestudy/chocolatebenefits.html”> New Health Benefits
Identified For Chocolate Comsumption </a>

The href tag specifies the universal resource locator (“URL”) of the web page referred to by the link, in the above example “http://www.health.foodscience.universityofplainsville.edu/news/chocolatestudy/choc olatebenefits.html,” as well as the text displayed for the link on the web page, in the above example “New Health Benefits Identified For Chocolate Consumption.” URLs are Internet-wide addresses for objects accessible via the Internet, and the above-described URL included in the href tag is the Internet address of an HTML document that describes a web page that can be displayed to a user by a browser running on a personal computer or other electronic device. URLs are commonly long character strings, often exceeding 200 characters in length. Moreover, a URL may be suffixed with additional information, following a demarcation symbol “?”, that can be passed to a server in the course of requesting the object specified by the URL from the server. That portion of the URL preceding the demarcation symbol “?” is a hypertext transfer protocol (“http”) address of an Internet-accessible object and the portion of the URL following the demarcation symbol “?” is generally referred to as the “search part,” although the information contained in the search part can be used by a server for tasks other than searching, for example as an argument to a Common Gateway Interface (“CGI”) script. One type of electronic device on which it is desirable to display web pages is a hand-held cellular telephone. The earliest, first generation cellular telephones used analog technology which modulates the telephone's radio signals, varying their frequency in a continuous manner, so that they can convey analog voice sound signals. Currently, most advanced cellular telephones are second generation, employing digital technology which converts sound signals to digital streams that are then used to modulate the wireless signals. Digital networks are also used for data communications.

A widely adopted second generation technology is the Global System for Mobile Communications (“GSM”), described generally in the publication GTS GSM 01.02 of the European Telecommunications Standards Institute, ETSI Infocentre, 06921 Sophia Antipolis Cedex, France. The GSM employs digital radio frequency signals, time-division multiplexed to allow full-duplex information exchange between a large number of mobile stations, such as cellular telephones, and a base station subsystem at rates up to 9600 bits per second. Other second generation wireless communications technologies, such as Sprint PCS, employ code division to multiplex digital radio signals.

Third generation broadband digital is an emerging technology that promises delivery of data at much higher rates, up to 2 million bits per second. One third generation standard is the Universal Mobile Telecommunications System, described generally in ETSI Document Number ES 201 385. UMTS is designed to comply with third generation standards while building upon established wireless technologies, notably GSM.

Within GSM, an important feature is a short messaging service (“SMS”) that allows reception of short-text messages by SMS-capable cellular telephones and that allows transmission of short-text messages by certain types of SMS-capable cellular telephones, as described in the ETSI publications GTS 03.40 and 03.41. In the following, an SMS-capable telephone is referred to as a “short message entity” (“SME”).

FIG. 2 illustrates the transmission of web pages from a server computer to an SME through an SMS network. In FIG. 2, a server computer 202 is interconnected with the Internet 204, to which the server computer transmits requests for HTML documents describing web pages and receives the requested HTML documents. The server computer 202 is linked to a short message service center (“SMSC”) 206, a message center for SMS messages that is linked via a gateway to a mobile switching center that controls calls to and from mobile phones and pagers. The SMSC 206 receives a text message representing the informational content of a web page or a portion of a web page from the server computer 202 and broadcasts the text message to a local cell tower 208, from which the text message is then rebroadcast to the SME 210. SMEs include short-message-service-mobile-terminated “(SMS-MT”) cell phones that can receive SMS text messages and short-message-service-mobile-originated (“SMS-MO”) cell phones that can both send and receive SMS text messages.

FIG. 3 illustrates the capabilities of SMS-MO cell phones and SMS-MT cell phones in the context of displaying web pages on a cell phone that are transmitted to the cell phone from a server computer through an SMS network. In FIG. 3, the server computer 302 accesses web pages on the Internet 304. The server computer then transcribes an accessed web page, or a portion of a web page, into an SMS text message 306 that is transmitted via an SMS network, such as the SMS network illustrated in FIG. 3, to an SMS-MT or SMS-MO cellular telephone 308. While an SMS-MT cellular telephone can only receive SMS messages, an SMS-MO cellular telephone may send an SMS text message 310 back to the server computer. The user of an SMS-MT cellular telephone can request an SMS text message from the server computer 302 by entering an access code, such as a phone number, via alphanumeric keys 312 and then enter a token, such as a “#” character followed by several digits. The user of an SMS-MO cellular telephone can also access SMS text messages provided by the server computer using this technique, but, in addition, may key in an alphanumeric SMS text message via the alphanumeric keys and transmit the keyed-in SMS text message to the server. The user of certain types of SMS-MO cellular telephones can reply to a SMS text message received from the server computer 302 by keying in a replay SMS text message via alphanumeric keys and transmitting the keyed-in response message using a reply button.

SMS text messages are formatted according to the SMS specification. An SMS text message includes a short, 30-byte header 314 and a message body 316 that can hold, at most, 160 ASCII characters.

A displayed web page, as discussed above, may contain a very large number of text characters, graphical images, and links. As discussed above, a link is specified within an HTML document as an href tag that may include a URL comprising hundreds of characters. Transmission of web pages to an SME is therefore severely constrained by the small text capacity of an SMS message. While the total information contained within a web page may be partitioned into smaller informational units by a server computer for transfer in separate SMS text messages to an SME, the occurrence of links exceeding 160 characters in length prevents such a link from being transmitted within a single SMS text message from the server computer to the SME. Thus, the server computer cannot embed a link containing an even modestly sized URL within an SMS text message. However, embedded links displayed within displayed SMS text messages are necessary for convenient browsing of the Internet by an SME user. Designers and manufacturers of SMEs and other hand-held electronic devices and designers and developers of Internet applications have therefore recognized the need for an efficient method for transmitting links to web pages or portions of web pages within short text messages transmitted from a server computer to an SME.

### SUMMARY OF THE INVENTION

One embodiment of the present invention provides a method for efficiently transmitting links embedded within HTML documents that describe web pages to a remote electronic device that displays information extracted from web pages. A server computer transcribes information contained in web pages into smaller units of textual information that can be transmitted to, and displayed on, the remote electronic device. Rather than embedding an HTML href tag or URL representing a link within the units of textual information, the server computer stores and maintains associations between URLs and link tokens, and embeds the link tokens within the units of textual information in place of URLs or href tags. In one embodiment, link tokens comprise small integers, allowing for 100 currently active link tokens to be maintained by the server for each active client electronic device. In another embodiment, the server maintains a separate link-token space for each currently served web page. Many additional alternative embodiments are possible.

### BRIEF DESCRIPTION OF THE DRAWINGS

FIG. 1 shows an example of a simple web page displayed on an electronic display device.

FIG. 2 illustrates the transmission of web pages from a server computer to an SME through an SMS network.

FIG. 3 illustrates the capabilities of SMS-MO cell phones and SMS-MT cell phones in the context of displaying web pages on a cell phone that are transmitted to the cell phone from a server computer through an SMS network.

FIG. 4 illustrates the concept of web-page transcription by a server computer.

FIG. 5 illustrates transcription of a graphics and link-containing web page into a unit of textual information displayable on an SMS-capable cellular telephone.

FIG. 6 illustrates the general protocol for allowing web browsing from a hand-held cellular telephone intercommunicating through an SMS network with a server computer.

FIG. 7 is a flow-control diagram describing the routine “addRef.”

FIG. 8 is a flow-control diagram for the routine “resolveLink.”

### DETAILED DESCRIPTION OF THE INVENTION

The present invention is directed to efficiently transmitting links embedded within units of information, such as web pages or portions of web pages, that are organized and interrelated in hierarchical trees or more general mesh-like graphs via the embedded links. While the present invention is particularly useful for transmitting links via request/response protocols in messages with limited information capacity, and for display of links on remote display devices with limited display characteristics, the present invention is generally useful for efficiently transmitting links to remote display devices. Although the present invention will be described in the context of serving information extracted from web pages to remote, hand-held electronic display devices such as cellular telephones, the present invention may be employed generally for transmitting and displaying links embedded within any type of hyperlinked information from an electronic serving entity to remote electronic browsing and display entities.

FIG. 4 illustrates the concept of web-page transcription by a server computer. At the request of a remote client display device, the server computer accesses an HTML document describing a web page either from a cache of HTML documents stored in memory or on local disk drives or other peripheral storage devices, or from remote servers via the Internet. The web page/HTML document 402 generally contains more information, and types of information, than can be displayed on the limited alphanumeric display of a cellular telephone. Therefore, the server computer 404 needs to filter and partition the information contained within the accessed HTML document in order to generate one or more small units of information 406-411 that can be transmitted to, and displayed at one time, on the remote electronic display device. In the example of displaying web pages on a hand-held SMS-capable cellular telephone with simple text display capabilities, all graphical, non-textual information contained within the HTML document described on the web page 402 is removed, potentially long href tags containing embedded URLs are replaced by link tokens, and the resulting text-based information is then partitioned into the smaller units of information 406-411 that can each be sent within a single SMS message and displayed on an SMS-capable cellular telephone.

The general web page transcription process is outside the scope of the present invention, and is not therefore described in detail. It should be noted, however, that there are many possible techniques for caching web pages on the server, transcribing the web pages, and possible caching the transcribed smaller units of information, such as units of information 406-411 in FIG. 4. For example, the transcription process may always occur dynamically, on demand, with no transcribed information saved on the server. Alternatively, a cache of transcribed smaller units of information may be maintained on the server. In either case, a particular unit of information corresponding to some portion of the information contained in an HTML file describing a web page may be uniquely addressed via a URL. In the case that the transcribed smaller units of information are cached in files, the URL corresponding to a particular smaller unit of information can be the address of the file cached on the server corresponding to the smaller unit of information. In the case that the small units of information are always generated dynamically, on demand, a URL specifying the HTML document with a search part specifying a particular portion of information contained in the HTML document can be used to specify a particular smaller unit of information. Thus, for the purposes of describing the present invention, it is assumed that smaller units of information into which a web page is decomposed by the server for transmission and display to a remote display device can be uniquely identified by a URL. However, many other addressing or location specifying techniques are possible, and can be used rather than URLs.

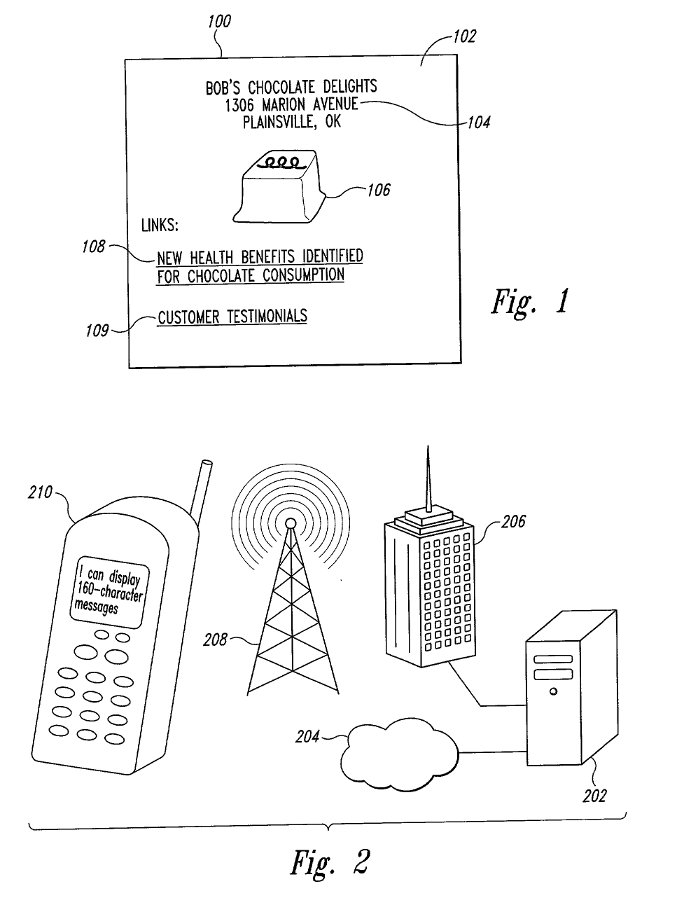

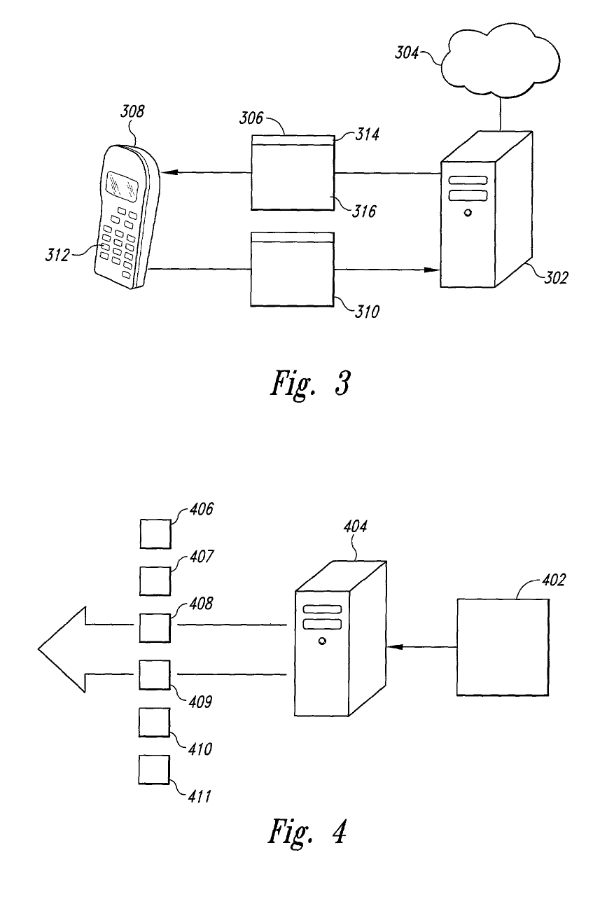

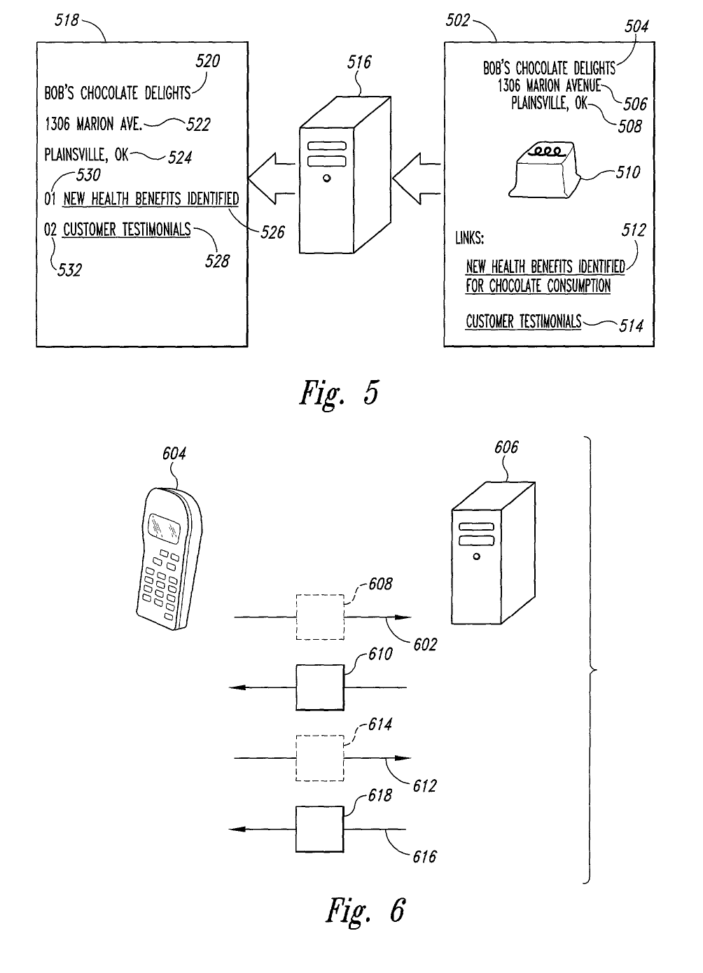

FIG. 5 illustrates transcription of a graphics and link-containing web page into a unit of textual information displayable on an SMS-capable cellular telephone. In FIG. 5, the web page 502, initially shown in FIG. 1, contains the name of a commercial entity 504, two address lines for the commercial entity 506 and 508, the image of a chocolate delight 510, and two embedded links 512 and 514. Because this web page 502 contains a rather small amount of information, web page 504 can be transcribed by a server computer 516 into a single unit of textual information 518 that can be transmitted in a single SMS message to a remote electronic display device for display to a user. Note that the textual information 504, 506, and 508 of the web page 502 is transcribed more or less directly into displayable text lines 520, 522, and 524 within the unit of textual information 518. Note that the graphical image of the chocolate delight 510 is not transcribable, and is simply omitted from the unit of textual information 518. Finally, note that the embedded links 512 and 514 are rather differently represented in the unit of textual information 518. The text representing link 512 in the web page 502 has been somewhat abbreviated in the corresponding text line 526 of the unit of textual information, so that it can be easily displayed on a single line. Both text lines representing links 526 and 528 in a unit of textual information 518 start with a small integers 530 and 532 that each constitutes a link token that both identify the text lines as links to the user and that can be employed by the user to request the units of textual information corresponding to the links. In the case that the web page 502 contains more than 160 characters of textual information, the server computer 516 can partition the web page 502 into some number of units of textual information, embedding additional links within the units of textual information to allow a user to navigate between the number units of textual information. As described above, a link token linking one unit of textual information to another may represent, and correspond to, a URL describing the linked-to unit of textual information stored on the server computer.

FIG. 6 illustrates the general protocol for allowing web browsing from a hand-held SMS-capable cellular telephone intercommunicating through an SMS network with a server computer. In a first step 602, the user of a cellular telephone 604 accesses, or logs on to, the server computer 606 via an initial message 608. The initial message is illustrated with dashed lines in FIG. 6 to indicate that several alternative types of messages are possible. For an SMS-MT cellular telephone, the initial access message may comprise entering a numeric or alphanumeric access code, such as a telephone number, via alphanumeric keys on the cellular telephone and activating a transmit or send button. In one embodiment, by accessing the server computer, a well-known web-page starting point, such as a search engine page or home page for a commercial entity, may be displayed to the user on the cellular telephone. In another embodiment, the user may embed one of several well-known codes, such as “#900,” into the access code, or provide the well-known code in a second step, to select the starting point, or initial page, for browsing. For an SMS-MO capable cellular telephone, the above-described access code technique may be employed or, alternatively, an SMS message containing the specification of a desired initial web page may be keyed into the hand-held cellular telephone and transmitted to a server computer.

In a second step of the protocol, the server computer transmits, within a single SMS message, an initial text-based unit of information 610 containing at least one link, to the hand-held cellular telephone. A user of the hand-held cellular telephone 604 can then view the initial information displayed on the display of the hand-held cellular telephone and can then solicit a new unit of information employing the one or more links contained within the currently-displayed unit of information. Thus, in a third step 612, the user selects a link and transmits the selection via a message 614 to the server computer 606. In the case of an SMS-MT cellular telephone, this message may require the user to input a numeric or alphanumeric access code followed by a numeric or alphanumeric link token that represents the selected link. For example, in one embodiment, embedded links within the information displayed to the user of a hand-held cellular telephone may comprise a small-integer link token, and the corresponding request code transmitted by the user to the server computer may be a “#” character followed by the small-integer link token. The user of an SMS-MO cellular telephone may also employ link tokens, as described above, or, alternatively, may select a displayed link token from a currently-displayed unit of information and return the selected link token by sending an SMS reply message to the server computer. Once the server computer 606 receives a link token representing a selected link, the server computer then returns, in a fourth step 616, the unit of information 618 corresponding to the selected link. This request/response protocol may continue as long as the user of the hand-held cellular telephone desires to browse web pages served by the server computer 606. An optional log-out step may terminate the browsing session.

In one embodiment of the present invention, the server computer maintains up to 100 associations between small-integer link tokens and URLs describing units of information referenced by the link tokens. This embodiment, and a second embodiment, described below, will employ relational database tables and SQL-like commands for storage and access of link-token-related information on the server computer. Of course, the information may be stored by the server computer in flat files, HTML documents, non-relational databases, or in any other information storage medium. The relational database technique is employed in the present discussion for the sake of preciseness, clarity, and brevity.

In the first embodiment, the server computer maintains two relational tables: (1) Table “A,” containing a current counter for each active client cellular telephone; and (2) Table “B,” containing active client/link-token/URL triples representing the association between a link token and a URL describing a unit of information for a particular active client, hand-held, cellular telephone.

An example Table A is provided below:

TABLE A

| counter | SME |
|---|---|
| 13 | 206 780 9991 |
| 100 | 206 676 7000 |

Table A contains two columns: (1) “counter,” containing wrap-around counters indicating the next link tokens, or references, that can be used to add new links to the link-token database maintained by the server; and (2) SME, containing identifiers, such as telephone numbers, of particular active client, hand-held, cellular telephones.

An example Table B is provided below:

| SME | Ref | page_address |
|---|---|---|
| 206 780 9991 | 3 | http://www.smserver.page . . . |
| 206 780 9991 | 1 | http://health.foodscience . . . |
| 206 676 7000 | 2 | http://www.bobs.customers . . . |
| 206 676 7000 | 8 | http://www.abcnews . . . |
| 206 780 9991 | 9 | http://www.smserver.page . . . |
| 206 676 7000 | 10 | http://www.smserver.page . . . |
| 206 676 7000 | 81 | http://www.smserver.page . . . |
| 206 676 7000 | 82 | http://komotu . . . |

Table B contains three columns: (1) “SME,” containing identifiers of particular active client, hand-held, cellular telephones; (2) “ref,” containing integer representations of small integers that serve as link tokens; and (3) “page_address,” a URL or other address that addresses a unit of information, such as a transcribed portion of a web page. Note that, in this table and in following tables and examples, an ellipsis “ . . . ” is used to avoid including full URLs.

By maintaining these two tables, the server computer can immediately transfer any received link token from an active client, hand-held, cellular telephone by retrieving the URL corresponding to a link token using an SQL-like command such as:

select page_address from B where (SME=206 780 9661 AND ref=3)

where the identifier of the cellular telephone from which the link token was received and the integer corresponding to the small-integer link token are specified in the where clause.

When a new client's cellular telephone logs into the server computer, as discussed above, the server computer can enter initial entries for the new client into Table A and Table B, based on the initial unit of information displayed to the new client, using SQL-like commands such as:

insert into B values (206 780 9991, 0, ‘http://www . . . ’)

insert into B values (206 780 9991, 1, ‘http://www . . . ’)

insert into A values (2, 206 780 9991)

In this case, the initial unit of information displayed to the new client contains two links, entries in Table B for which are entered by the first two above SQL-like statements, and the counter for the new client is inserted into either Table A by the third above SQL-like statement. The counter, in this case, represents the first unused small-integer integer that can be used as a subsequent link token for the next link for the new client added to the database.

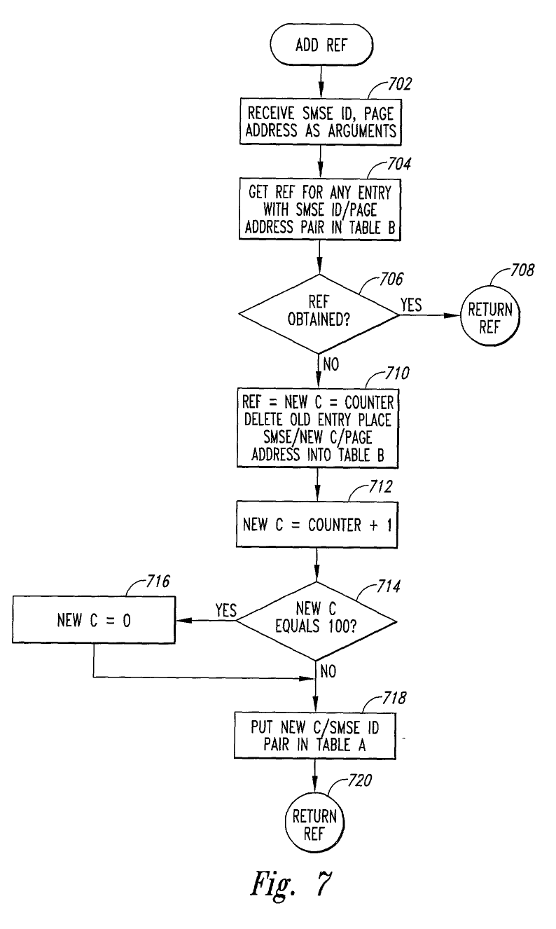

When the server computer prepares a subsequent unit of information for display to a client cellular telephone, for example by transcribing a web page accessed via the Internet, the server computer identifies each embedded link within the web page, substitutes a link token in a corresponding unit of information for the link, and stores an entry representing the association between the link token and a URL describing a web page or unit of information to which the original link is directed in Table B. This process is illustrated in the routine “addRef.” FIG. 7 is a flow-control diagram describing the routine “addRef.” In step 702, the routine “addRef” receives the ID of the client cellular telephone for which the reference is to be added and the page address, or URL, to which the reference is directed, as arguments. Note that the page address may be the address of a web page or a transcribed unit of information, depending on the implementation and on the particular link to be added. In step 704, the routine “addRef” queries Table B in order to determine whether a link token is already associated with the supplied page address and the supplied client-cellular-telephone identifier provided as arguments in step 702. One example of a method for determining whether a link token is already associatied with the page address and client is use of the following SQL-like command:

select COUNT(*) from B where (B.SME=206 780 9991 AND B.page_address=‘http://www . . . ’)

which returns a value of 1 if an entry already exists in Table B, and a value of 0 if no entry exists in Table B. If the link token/page address/client association exists in Table B, the following SQL-like statement can be used to determine the link token corresponding to the page address and client, supplied as arguments in step 702:

select ref from B where (B.SME=206 780 9991 AND B.page_address=‘http://www . . . ’)

Thus, if a ref, or link token, for the page address and client can be found in Table B, as determined by addRef in step 706, then the local variable “ref” is set to the value of the found link token in step 704, is returned by addRef in step 708, and the client server can embed the returned link token “ref” within the unit of information prepared for transmission to the active client's cellular telephone.

If no link corresponding to the page address and active client supplied as arguments in step 702 is found in Table B, then the routine “addRef” continues to step 710. In step 710, addRef obtains the current counter value for the active client and assigns the current counter value to the variable “newC.” The current counter value can be obtained from Table A via an SQL-like command such as:

select counter from A where (A.SME=206 780 9991)

Also in step 710, the entry in Table A for the active client is deleted via a SQL-like command such as:

delete from A where (A.SME=206 780 9991)

Finally, in step 710, addRef enters the association between the link token represented by the value in variable “newC,” the page address, or URL, supplied as an argument in step 702, and the identity of the client cellular telephone as an entry into Table B using an SQL-like insert command similar to the above-provided SQL-like insert commands that insert entries into Table B. In step 712, addRef increments the value in variable “newC.” In step 714, addRef determines whether the value contained in variable “newC” equals 100. If so, then addRef wraps the counter by assigning the value “0” to the variable “newC” in step 716. Finally, in step 718, addRef inserts the pair newC/SME representing the value of the current counter for the client cellular telephone identified by the SME identifier into Table A using an SQL-like insert command similar to the above-provided SQL-like insert command directed to Table A. The value in local variable “ref” is returned to the client server by addRef in step 20.

In an alternate embodiment for maintaining link/URL associations involves maintenance of three relational tables by the server computer: (1) Table C, containing associations between page_no identifiers that identify web pages or units of information transcribed by the server computer from web pages, and SME identifiers of active clients; (2) Table D, which contains associations between page_no web page or unit of information identifiers and page addresses, commonly URLs; and (3) Table E, which contains page_no/link token/URL triples that describe the associations between small-integer link tokens and URLs for currently served units of information, such as web pages, transcribed web pages, or transcribed portions of web pages.

An example Table C is provided below:

| page_no | SME |
|---|---|
| 4 | 206 780 9991 |
| 863 | 206 676 7000 |

Table C contains the following columns: (1) page_no, containing identifiers of units of information that are currently displayed to active clients or of the web page from which the units if information were transcribed; and (2) SME, containing identifiers of the active clients to which the units of information are displayed.

An example Table D is provided below:

| page_no | page_address |
|---|---|
| 3 | ‘http://www . . .’ |
| 9961 | ‘http://www . . .’ |

Table D contains the following two columns: (1) page_no, containing identifiers of actively served units of information; and (2) page_address, containing URLs or other types of addresses that identify the units of information corresponding to the unit-of-information identifiers contained in column “page_no.”

| page_no | ref | page_address |
|---|---|---|
| 3 | 0 | ‘http://www . . .’ |
| 3 | 1 | ‘http://www . . .’ |
| 3 | 2 | ‘http://www . . .’ |
| 3 | 3 | ‘http://www . . .’ |
| 4 | 0 | ‘http://www . . .’ |
| 4 | 1 | ‘http://www . . .’ |
| 5 | 0 | ‘http://www . . .’ |
| 5 | 1 | ‘http://www . . .’ |

Table E contains the following three columns: (1) page_no, containing identifiers of actively served units of information; (2) ref, containing integer representations of small-integer link tokens; and (3) page_address, containing URLs or other types of addresses that address the units of information identified by the corresponding values in column “page_no.”

Thus, the server computer stores, in Table C, an identifier for each active client that identifies the unit of information, such as a transcribed web page, that is currently being accessed by the active client. The server computer stores associations between page_no identifiers of units of information and URLs in Table D. In Table E, the server computer stores associations between link tokens and URLs for the links embedded in each actively served unit of information. Depending on the size of the database, Table E may contain link token/URL associations for previously-accessed units of information as well as currently-accessed units of information.

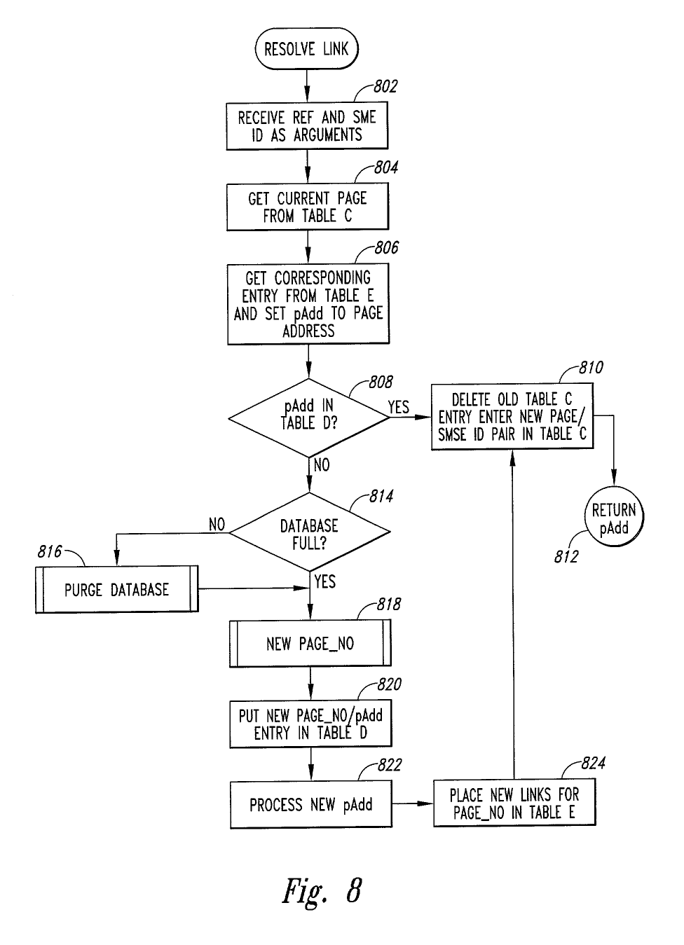

When the server computer receives from an active client cellular telephone a link selection requesting transmission by the server computer of a unit of information corresponding to the link to the active client cellular telephone, the server computer may call a routine such as the routine “resolveLink,” described below, to resolve the link token into a URL or other type of address, so that the server computer may fetch the unit of information using the URL in order to return to the requesting active client cellular telephone. FIG. 8 is a flow-control diagram for the routine “resolveLink.” In FIG. 8, the routine “resolveLink” receives a link token in the variable “ref” and an identifier identifying an active client cellular telephone as arguments in step 802. In step 804, resolveLink obtains the unit of information currently displayed to the active client cellular telephone from Table C using an SQL-like command such as:

select page_no from C where (S.SME=206 780 9661)

Then, in step 806, resolveLink obtains the URL for the unit of information corresponding to a link token from Table E using an SQL-like command such as:

select page_address from E where (E.page_no=3612)

In step 806, resolveLink sets the local variable “pAdd” to the URL obtained from Table E. Thus, in step 806, the routine “resolveLink” has resolved the link supplied in step 802 to a URL that can be used to obtain the desired unit of information and return the unit of information to the requesting client computer. However, resolveLink may additionally need to update Tables C, D, and E to reflect the fact that the client cellular telephone has accessed the new unit of information referenced by the URL stored in local variable “pAdd.” In step 808, resolveLink determines whether there is an entry in Table D with page_address equal to the value stored in pAdd. If so, then Tables D and E do not need to be updated. Control flows to step 810, where the entry for the active client computer in Table C is deleted and a new entry inserted to reflect the identity of the unit of information currently accessed by the active client computer, using an SQL-like insert command. Then, in step 812, resolveLink returns the URL corresponding to the supplied link token to the server computer to allow the server computer to transmit the unit of information described by the URL to the active client cellular telephone. There is, in this scheme, a short time frame during which the database will be updated to reflect the newly accessed page, while the client continues to display the previously accessed page. Problems arising from such temporal disparities can be handled by any of many well-known database techniques used to properly synchronize, commit, and roll back failed transactions.

If no entry in Table D contains the URL contained in local variable “pAdd,” then Tables D and E must be updated. In step 814, resolveLink determines whether there is space in the database for inserting new entries into Table D and E. If not, then in step 816, stale entries within the database are purged. Various types of purge algorithms may be employed. For example, entries for pages with page_no identifiers not occurring in Table C may be deleted from Tables D and E, so that only actively served units of information remain in the database. As another example, an additional column may be maintained in Table E to indicate how recently a particular link was last selected, and the least most recently selected links may be deleted from Table E. Many other possible purge algorithms exist. Next, in step 818, a new page_no identifier is obtained. Again, many types of algorithms are possible for generating new page_nos. As one example, sufficiently long integer representations of page_no identifiers may be used so that there is no possibility of a page_no identifier exceeding the maximum integer that can represented, and each new page_no can therefore be obtained by incrementing the value of the last page_no generated. As another example, when an entry in Table D is deleted in step 816, the page_no identifier contained in the entry may be returned to a pool of available page_no identifiers. Next, in step 820, a new entry is inserted into Table D containing the new page number and URL contained in local variable “pAdd.” In step 822, the unit of information corresponding to the URL contained in local variable “pAdd” is processed by the server computer to identify all embedded links and assign small-integer link tokens for each link. In step 824, an entry is inserted into Table E for each link token generated in step 822. Then, control flows to step 810 and 812, as previously described.

When the remote electronic display devices have capabilities other than those described for SMS cellular telephones, a server computer may employ different, more suitable strategies for transcribing web pages into units of information that can be displayed on the remote electronic display devices. In the future, as the capabilities and processing power contained in remote electronic display devices increases, it is conceivable that very little transcription by server computers may be necessary, and web pages may be more directly transferred to the server computer to the remote electronic display devices. However, even in that case, the present invention may still be employed to more efficiently transmit embedded links within web pages or other units of information from a server computer to a remote display device. The present invention generally allows potentially lengthy embedded links to be represented by very short tokens in order to decrease the amount of information transferred from a server computer to a remote display device at the cost of maintaining link-token/unit-of-information address associations in the server computer and the cost of processing selected link tokens transmitted to the server computer from remote electronic display devices into URLs or other address-like specifiers of units of information corresponding to link tokens.

Although the present invention has been described in terms of a particular embodiment, it is not intended that the invention be limited to this embodiment. Modifications within the spirit of the invention will be apparent to those skilled in the art. For example, many different types of numeric or alphanumeric link tokens may be employed, including numeric tokens and character string tokens. There are an almost limitless number of ways of maintaining link tokens/unit-of-information-address associations within the server computer. In the above description, two different relational-database-based schemes were described, but many other types of relation-database implementations are possible, as well as a much larger number of non-relational-database implementations.

The foregoing description, for purposes of explanation, used specific nomenclature to provide a thorough understanding of the invention. However, it will be apparent to one skilled in the art that the specific details are not required in order to practice the invention. In other instances, well-known circuits and devices are shown in block diagram form in order to avoid unnecessary distraction from the underlying invention. Thus, the foregoing descriptions of specific embodiments of the present invention are presented for purposes of illustration and description; they are not intended to be exhaustive or to limit the invention to the precise forms disclosed, obviously many modifications and variations are possible in view of the above teachings. The embodiments were chosen and described in order to best explain the principles of the invention and its practical applications and to thereby enable others skilled in the art to best utilize the invention and various embodiments with various modifications as are suited to the particular use contemplated. It is intended that the scope of the invention be defined by the following claims and their equivalents:

1. A method for transmitting a link to a first unit of information, embedded in a second unit of information, from a server computer to a remote cellular telephone, the method comprising:
providing a link token;
storing an association between the link token and the embedded link in a storage device;
transmitting information from the second unit of information, with the embedded link replaced by the link token, to the remote cellular telephone in a short text message.

2. The method of claim 1 wherein the first and second units of information are first and second formatted text documents that describe web pages and wherein the embedded link comprises formatted text within the second formatted text document that includes an address of the first formatted text document.

3. The method of claim 2 wherein the address is a uniform resource locator that describes the address of the first formatted text document.

4. The method of claim 1 wherein the first unit of information is a formatted text document that describes a web page, wherein the second unit of information is text information transcribed from a second formatted text document that describes a web page, and wherein the embedded link comprises formatted text within the second formatted text document that includes an address of the first formatted text document.

5. The method of claim 4 wherein the address is a uniform resource locator that describes the address of the first formatted text document.

6. The method of claim 4 wherein the address describes the location of information transcribed from the first formatted text document.

7. The method of claim 4 wherein the address describes the information within the first formatted text document to be transcribed into the text information.

8. The method of claim 1 wherein providing a link token further includes selecting a text-based token comprising a number of characters, digits, or characters and digits that, together with an identifier identifying the cellular telephone, uniquely identifies the link.

9. The method of claim 1 wherein providing a link token further includes selecting a text-based token a number of characters, digits, or characters and digits that, together with an identifier identifying the first unit of information, uniquely identifies the link.

10. The method of claim 1 wherein storing an association between the link token and the embedded link in a storage device further includes storing the link token paired with the address of the first unit of information in an electronic memory.

11. The method of claim 1 wherein storing an association between the link token and the embedded link in a storage device further includes storing the link token paired with the address of the first unit of information in a file stored on a mass storage device.

12. The method of claim 1 wherein storing an association between the link token and the embedded link in a storage device further includes storing the link token paired with the address of the first unit of information in a relational database table.

13. The method of claim 1 wherein storing an association between the link token and the embedded link in a storage device further includes removing a previously stored association between the link token and a different embedded link from the storage device prior to storing the association between the link token and the embedded link in the storage device.

14. The method of claim 1 wherein transmitting information from the second unit of information, with the link replaced by the link token, to the remote cellular telephone in a short text message further includes copying the information into a short-message-service message and transmitting the short-message-service message through a short-message-service network to the cellular telephone.

15. A method for transmitting a request for a first unit of information from a cellular telephone to a server computer, the method comprising:
identifying a link token in a second unit of information displayed on the cellular telephone;
selecting the link token; and
transmitting the selected link token to a server computer.

16. The method of claim 15 wherein the link token is a text-based token comprising a number of characters, digits, or characters and digits that, together with an identifier identifying the cellular telephone, uniquely identifies the first unit of information to the server computer.

17. The method of claim 15 wherein the link token is a text-based token comprising a number of characters, digits, or characters and digits that, together with an identifier identifying the first unit of information, uniquely identifies the first unit of information to the server computer.

18. The method of claim 15 wherein transmitting the selected link token to a server computer further includes accessing the server computer through a global system for mobile communications network and transmitting the link token to the server computer through the global system for mobile communications network.

19. The method of claim 15 wherein transmitting the selected link token to a server computer further includes embedding the link token in a short-message-service message and transmitting the a short-message-service message to the server computer through a short message-service-network.

20. A web-page serving system for serving hyperlinked information extracted from web pages to a cellular telephone, the web-page serving system comprising:
a server computer that transcribes web pages into corresponding units of information transmittable to, and displayable on, the cellular telephone, transcrition of web pages including substituting link tokens for links embedded in the web page and storing corresponding link-token/embedded link associations for subsequent access by the server computer; and
a short message service network that interconnects the server computer with the cellular telephone and through which the server transmits units of information that include link tokens to the cellular telephone.

21. The web-page serving system of claim 1 wherein each link embedded in the web page includes a uniform resource locator that describes the location of a formatted text document that defines a web page.

22. The web-page serving system of claim 1 wherein a link token comprises a number of characters, digits, or characters and digits that, together with an identifier identifying the cellular telephone, uniquely identifies a web page.

23. The web-page serving system of claim 1 wherein a link token comprises a number of characters, digits, or characters and digits that, together with an identifier identifying the cellular telephone, uniquely identifies information transcribed from the server computer from a web page.

24. The web-page serving system of claim 1 wherein a link token comprises a number of characters, digits, or characters and digits that, together with an identifier identifying a unit of information currently displayed on the cellular telephone, uniquely identifies a web page.

25. The web-page serving system of claim 1 wherein a link token comprises a number of characters, digits, or characters and digits that, together with an identifier identifying a unit of information currently displayed on the cellular telephone, uniquely identifies information transcribed from the server computer from a web page.
